(19) United States
(12) Patent Application Publication
(10) Pub. No.: US 2003/0233962 A1
(43) Pub. Date: Dec. 25, 2003

(54) Pozzolan modified portland cement compositions and admixtures therefor

(76) Inventor: Jonathan E. Dongell, Scottsdale, AZ (US)

Correspondence Address: JONATHAN E. DONGELL, 11050 E. LAUREL LANE, SCOTTSDALE, AZ, 85259, US

(21) Appl. No.: 10/177,918

(22) Filed: Jun. 21, 2002

(51) Int. Cl. C04B 7/13

(52) U.S. Cl. 106/709; 106/705; 106/706; 106/708

(57) ABSTRACT

A pozzolan admixture composition suitable for use in portland cement mixtures and mix designs that, when combined with; portland cement, sand and/or aggregate, and water, are used to prepare cementitious products. The admixture contains ultra-fine fly ash, calcined kaolin, fused silica, and cellulose ether derivative. A pozzolan-modified portland cement composition containing the present invention's composition inter-ground or inter-blended with a portland cement. The pozzolan-modified portland cement contains portland cement, ultra-fine fly ash, calcined kaolin, fused silica, and a cellulose ether derivative. An admixture, additive, or addition, based on the present invention's composition, inter-ground or inter-blended into portland cement to create such pozzolan-modified portland cements. An admixture, additive, or addition, based on the present invention, that is subsequently added or mixed into a read-mix or wet mixture of portland cement, sand and/or aggregate, and water, containing ultra-fine fly ash, calcined kaolin, fused silica, and cellulose ether derivative.

### FIELD OF THE INVENTION

The present invention relates generally to the field of cementitious products, and more particularly to improved pozzolan-modified portland cement compositions and pozzolan admixture compositions that are mixed with portland cement for making cementitious products that when mixed in a conventional manner with water, sand and/or aggregate, produce cementitious products which are less permeable, have greater workability, are resistant to attack from chemicals and aggressive water, avoid subsequent leaching of calcium hydroxide, and exhibit significantly less heat of hydration than heretofore possible.

### BACKGROUND OF THE INVENTION

The Ancient Egyptians and Romans practiced the art of making and using of pozzolan, as a cementitious product. The benefits of using a pozzolan were first discovered empirically. Pozzolans are generally high in siliceous or in siliceous and aluminous materials. Pozzolans include a wide variety of materials; some pozzolans are naturally occurring such as, but not limited to; certain clays and volcanic ashes that were available, and employed, in ancient times. Other pozzolans are artificially produced such as, but not limited to, fly ash and silica fume.

Pozzolan cements were widely used in the western world and elsewhere until at least the early 1940's when it became evident that the advancing technologies in the manufacture of portland cement offered many advantages. A significant drawback as the pace of construction, and life itself increased was that pozzolan cement had a slow strength gain. This inhibited its' use in many structural applications. Brick or steel was therefore used for most large structures. The inability to control and increase the speed of the set time of pozzolan cement, as well as the likely related inability to achieve the necessary early strength gain, indicated against its' use in most massive structures.

In comparison with pozzolan cement, advancements in the technology of the manufacture of portland cement had reached a level that the necessary rapid strength gain and speed of set time allowed concrete to become a preferred construction material. Further technological advances allowed portland cement to be ground finer and calcining processes to become more refined as well. These beneficial increases proved to be the reason for the eventual downturn in the use of pozzolans in cementitious materials. However, in the 1960's, the industry renewed its interest in pozzolanic cements and pozzolanic additives to portland cement. The use of such additives has been steadily increasing from the 1960's to the present.

As stated above, pozzolans are generally high in siliceous or in siliceous and aluminous materials. The chemical and physical mechanisms by which pozzolans react with cement to affect the properties of the resulting cementitious products are not fully understood although it is known that pozzolans usually have no cementing properties of their own. It was generally believed that the benefit pozzolans brought to cementitious products resulted from their ability to combine with free lime or calcium hydroxide in cement to create an insoluble compound having cementing properties.

Thus, an important benefit that pozzolans offered to cementitious products was their ability to react with portland cements' weakest compound, calcium hydroxide, forming a stronger calcium silicate, thereby rendering the cementitious product more durable than otherwise possible. However some pozzolanic constituents react slower than others do. While these constituents improve the resistance of the cementitious product to aggressive water attack, the improvement in durability may not come quickly enough to allow the use of such pozzolans in some applications. A rapid improvement in durability is particularly critical in those applications in which cementitious products were to be used in a water-contact situation. Examples of water contact situations include, but are not limited to bridges, piers, and swimming pool construction.

Other pozzolanic constituents react faster, but the cementitious products made with these pozzolanic constituents were generally not very durable. What was needed was a pozzolanic mixture that exhibited both rapid chemical reaction and a rapid increase in the strength of the cementitious product with which they were mixed.

Pozzolans include a wide variety of materials; some pozzolans are naturally occurring such as, but not limited to, certain clays and volcanic ashes. Other pozzolans artificially produced such as, but not limited to, fly ash and silica fume. Each pozzolanic material possesses different properties and, as a result, performs differently with portland cement. The fineness of the pozzolan, the degree with which a pozzolan is calcined or naturally formed, and the chemical and physical make-up of the pozzolan, are just a few of the variables of the pozzolan which determine the rate of reaction with portland cement, as well as, the properties that the resulting cementitious product posses.

As should be apparent from the above, no two pozzolan are alike. The resulting performance of each pozzolan in a cementitious product must therefore be analyzed for the desired properties. As this is still somewhat empirical, there is no sure way to predict how a pozzolan-modified portland cement will perform until it is formulated and tested for a given application.

Garrett, U.S. Pat. No. 6,324,822 issued Dec. 4, 2001 purportedly teaches the usage of a plurality of pozzolans and polymers that are based on “silica fume” pozzolan. Silica fume is specific type of amorphous silica defined by the American Concrete Association as the waste by-product from the production of certain siliceous metals. However, Garret offers no clarification of what exactly constitutes a good silica fume. In addition Garrett does not disclose what processes or procedures are necessary to achieve optimal reactivity, some acceptable level of reactivity, or any reactivity at all with the portland cement. The other pozzolans described, or claimed, also have no specifications. As discussed above, the fineness, the chemical composition, and the mineralogy of a natural pozzolan, synthetic pozzolan, or man-made pozzolan, are directly related to the chemical reactivity that a pozzolan will ultimately have with the portland cement. This absence of the vital information that should define or specify many of the materials disclosed and claimed, which is necessary to allow one of ordinary skill in this art to practice the invention, appears on its' own to emasculate the validity of both any teachings of Garrett and of the claims.

Other prior pozzolanic cementitious products like Smetana, U.S. Pat. No. 5,302,200 (1994), and Mehta, U.S. Pat. No. 5,346,548 (1994), and, Turpin, Jr., U.S. Pat. No. 4,313,763 (1982), used either silica fume, ground blast furnace slag, or coal fly ash, which suffer from an aesthetically offensive dark color that the pozzolans impart to the resulting product. Darkly colored cementitious products are unacceptable for many applications where a light colored cementitious product is desired. Examples of where a light-colored cementitious product might be preferred would be in swimming pool construction and in certain architectural precast members. Also, single pozzolans, while contributing certain positive qualities to cementitious products, may also impart negative contributions as well. For example, silica fume has a high water demand, which can affect a cementitious product adversely. Silica fume can be “sticky” or increase slump, which can make certain cementitious materials difficult to pump or place.

Jesky, U.S. Pat. No. 3,982,954 (1976), teaches other prior art pozzolan-modified cementitious products. Turpin, Jr., U.S. Pat. No. 4,256,500 (1981), also adds a single pozzolan component to a cementitious product. Bainton, U.S. Pat. No. 3,953,222 (1976), teaches the acidification of a pozzolan prior to mixing with portland cement. Other references that teach the combination of portland cement and a pozzolan to produce materials other than cement are Walter et al., U.S. Pat. No. 5,324,469 (1994); and Turner, U.S. Pat. No. 5,391,245 (1995). None of these however, teach the use of a plurality of pozzolanic materials and additives to form a superior pozzolanic combination which when introduced to portland cement, whether by inter-grinding or pre-blending, or whether introduced subsequently as an admixture, will optimize the desirable properties of the resulting cementitious product.

A prior patent issued to the author of this patent, Dongell, U.S. Pat. No. 5, 588,990 (1996), teaches a usage of a plurality of natural pozzolans but does not offer any polymer additives, synthetic pozzolans, or refined man-made pozzolans that have since come into being, which unexpectedly give greater control of set, more rapid strength gain, and lower the water:cement ratio thereby increasing the overall durability of the cementitious product using the present inventions novel compositions.

There is a need to optimize the combination of pozzolanic and polymeric materials, as well as, optimize the pozzolanic and polymeric ingredients themselves. Optimizing the man-made pozzolans, synthetic pozzolans, natural pozzolans and polymeric additives is a novel part of this invention. No invention has heretofore used the present invention's combinations of materials or has heretofore optimized the chemical reactivity of certain of the present invention's individual ingredients, through unique manufacturing and refining techniques. And further, to be complimenting of one another when in combination, to that of the total composition of cementitious materials. Further, there is an unmet need to demonstrate how one can adjust or modify such a combination, within defined ranges to prepare a cementitious product that more exactly meets the criteria or demands for the ease of placement, or for its durability in certain placement environments, such as, but not limited to; lower permeability, greater workability, rapid strength recovery, control of set time, high resistance to chemical and/or water attack, ease of application, and lower heat of hydration. A pozzolanic cementitious product, which further optimizes such desirable properties is still lacking in the art. It is toward this laudable end that the present invention is directed.

### BRIEF SUMMARY OF THE INVENTION

The present invention relates generally to a unique pozzolanic modification to portland cement, whether inter-ground or blended with the portland cement, or later added as an admixture therefor, in making cementitious products. Specifically, the present disclosure describes improved multi-pozzolanic and polymeric compositions to be introduced as admixtures, pozzolan-modified blended portland cements, or pozzolan-modified inter-ground portland cements, which when used as directed will produce cementitious products possessing less permeability, greater durability, higher workability, greater resistance to early attack from chemicals and aggressive water by lessening the subsequent leaching of the calcium hydroxide compound from the portland cement. In addition using the present invention results in a significantly lowered heat of hydration, which otherwise can cause uncontrollable setting speeds or initiate secondary deterioration mechanisms. One way of explaining the parameters of the present invention is to consider it when added to the portland cement, which is described herein as a pozzolan-modified portland cement.

Preferably, the total weight of a pozzolan-modified portland cement, whether inter-ground with the portland cement or blended with the portland cement, when the present invention has been added thereto, as a part of the mixture with a calcined kaolin, an ultra-fine fly ash, a fused silica, and with or without a cellulose ether derivative or its equivalent, the resulting pozzolan-modified cement blend contains from about 65% to about 88% (w/w) of portland cement, from about 5% to about 27% (w/w) of calcined kaolin, from about 3% to about 27% (w/w) of ultra-fine fly ash, from about 1% to about 15% (w/w) of fused silica or its functional equivalent, and from about 0% to about 1.0% cellulose ether derivative.

Applicant believes that additions of a cellulose ether derivative or its functional equivalent, and ultra-fine fly ash of the present invention, aid in promoting the workability and in lowering the water:cementitious ratio and therefore compliment the calcined kaolin and the fused silica of the present invention which have the inverse affect on the workability and the water:cementitious ratio. In addition, using a small portion of the pozzolanic ingredients that are of a slightly more coarse material further enhances workability. If approximately 5% to 10% of the pozzolanic portion are retaining on a 200 mesh (75 microns), while the remaining 90% to 95% passes the 325 mesh (45 microns), the workability of the resulting cementitious product is unexpectedly superior than if all ingredients were passing (finer than) the 325 mesh (45 microns).

The present invention also includes the pre-preparation of any admixtures analogous to the inter-ground portland cement or the blended portland cement of the present invention or the subsequent addition of a portland cement, whether in the dry mixing of the portland cement or the ready mixing of the portland cement, with water mixed together with the pozzolanic admixture to produce cementitious products.

The composition can be used as, but is not limited to, mortar, concrete, plaster, precast, stucco, gunite, shotcrete, swimming pool finishes, and grout. The cementitious product of the present invention may be used in, but is not limited to, the construction of buildings, dams, bridges, roadways, slabs, pre-fabricated units, architectural casting, and swimming pools. It may also be used with reinforcement such as, but is not limited to; rebar, expanded metal lath, woven-wire or welded-wire mesh, fiberglass mesh, fiberglass fiber, carbon fiber, and the like.

When the total weight of the admixture of the present invention contains a mixture with a calcined kaolin or its functional equivalent, an ultra-fine fly ash, fused silica or its functional equivalent, and with or without a cellulose ether derivative or its equivalent, the resulting admixture preferably contains approximately; from about 17.5% to about 67% (w/w) of ultra-fine fly ash, from about 20% to about 67% (w/w) of calcined kaolin, from about 7% to about 22.5% of fused silica, and from about 0.1% to about 2.0% (w/w) of a cellulose ether derivative, or its functional equivalent.

The admixture may also contain from about 0% to about 20% (w/w) of an “inert filler” such as, but not limited to; a calcium carbonate, a dolomite, a talc, a calcium bentonite, or a functional equivalent to act as an “inert filler”. Such an “inert filler” is well known in the art as a bulking material or filler. This material has multiple mechanical, commercial and other purposes.

On one hand the inert filler may be used to produce a volume of material that more closely relates to a specific volume, weight, or mass, per bag or per batch, which is needed or preferred by the mixer, the end user, or the producer, to reduce potential mis-proportioning in the field. The present invention will be used in an industry where batching or mixing are often done by “rule of thumb”, or according to long established custom. Therefore emphasizing the ease of use of the invention in the field is possibly critical to creating a commercially viable product. Also, fillers are well known in the art and for commercial purpose to render more difficult the possible attempts to reverse engineer or otherwise circumvent the precise formulation used. This, however, is a mere ancillary benefit from the operational reasons for using fillers. In any event, the description of “inert filler” is merely made to clarify that the use of such fillers neither avoids the scope of the present invention, nor is essential to the use of the present invention.

Accordingly, a prime object of the present invention is to provide an improved and novel composition for making cementitious products which exhibit one or more of the following characteristics: quicker strength recovery, greater workability, less permeability, more resistance to chemical attack, more resistance to aggressive water (thereby reducing the leaching of calcium hydroxide), and a lower heat of hydration.

A further object of the present invention is to provide a novel pozzolanic admixture, or pozzolanic portland cement composition with portland cement, compromising; ultra-fine fly ash, calcined kaolin, fumed silica, and sufficient cellulose ether derivative, to make a final cement composition that, while possessing the needed work-ability and flow-ability, reduces the water demand of the total volume of cementitious materials, which in turn, reduces the water:cementitious materials ratio (w/w).

These and still other objects are readily accomplished in a novel and unique manner that will become more readily apparent from a reading of the detailed description below and the claims appended hereto.

### DESCRIPTION OF THE PREFERRED EMBODIMENT

When the present invention is produced or manufactured as an pozzolan-modified inter-ground or blended portland cement comprising portland cement, ultra-fine fly ash, calcined kaolin, fused silica, and a cellulose ether derivative, the preferred ranges are: from about 65% to about 88% (w/w) portland cement; from about 5% to about 27% (w/w) calcined kaolin or its functional equivalent; from about 3% to about 27% (w/w) ultra-fine fly ash; from about 1% to about 15% (w/w) fused silica or its functional equivalent; and from about 0% to about 1.0% (w/w) cellulose ether derivative or its functional equivalent, weight percentages (w/w) being taken relative to the total weight of the dry cementitious materials. Where sufficient water reducing capacity is already present by attribute of the three pozzolanic ingredients of the present invention, no addition of the cellulose ether derivative may be needed. If an insufficient water reducing capacity of the mixture is present, or a more effective water reducing capacity is needed, then the cellulose ether derivative or its functional equivalent, may be added to the mixture to insure the resulting cementitious material contains the optimum amount water reducing capability that the specific end-user needs or desires.

When the present invention is produced or manufactured as an inter-ground or blended cement comprising only portland cement, ultra-fine fly ash, fused silica, and a cellulose ether derivative, the preferred-ranges are: from about 65% to about 88% (w/w) portland cement; from about 3% to about 27% (w/w) ultra-fine fly ash; from about 1% to about 15% (w/w) fused silica or its functional equivalent, and from about 0.05% to about 1.0% cellulose ether derivative or its functional equivalent.

When the present invention is produced or manufactured as an inter-ground or blended cement comprising portland cement, ultra-fine fly ash, calcined kaolin, and a cellulose ether derivative, the preferred ranges are: from about 60% to about 85% (w/w) portland cement; from about 3% to about 27% (w/w) ultra-fine fly ash; from about 5% to about 27% (w/w) calcined kaolin or its functional equivalent, and from about 0.05% to about 1.0% cellulose ether derivative or its functional equivalent.

The present invention's admixture herein disclosed is analogous to the pozzolan-modified inter-ground or blended portland cement of the present invention in that the admixture contains no portland cement but does contain the same selection of the other ingredients in relative proportions analogous to those stipulated for the corresponding inter-ground portland cement or blended portland cement. The present invention's pozzolan-modified portland cement mixture anticipates the situation where said pozzolans are to be mixed with the portland cement, whether by inter-grinding or by dry blending thus producing a said pozzolan-modified portland cement product. The present invention's anticipates a ready-mixed or wet mixture cementitious product, with the inclusion of sand, and/or aggregate, and water that is mixed with either the present invention's pozzolanic admixture and portland cement or with the present invention's pozzolan-modified portland cement.

The present invention includes any cementitious material that is produced, manufactured, mixed, or blended, using individual components that, when combined, create the present invention's formula. The present invention also includes any cementitious material that is produced, manufactured, mixed, or blended, using various combinations of ingredients that, when combined, create said invention's formula. The present invention further includes any cementitious product that may require the use of fillers, set modifiers, water, sand, and/or aggregate, or other ingredients that are typically necessary to create certain precast, concrete, plaster, or other cementitious products in addition to said invention's formula in order to make the final novel pozzolanic cementitious product.

When the present invention is produced, manufactured, or blended as an admixture to be added to portland cement, consisting of only ultra-fine fly ash, calcined kaolin, fused silica, and a cellulose ether derivative, the preferred ranges are: from about 12.5% to about 67% (w/w) of ultra-fine fly ash; from about 17.5% to about 67% (w/w) of calcined kaolin or its functional equivalent; from about 7% to about 22.5% (w/w) of fused silica of its functional equivalent; and from about 0.1% to about 2.0% (w/w) of cellulose ether derivative or its functional equivalent, the weight percentages (w/w) being taken relative to the total weight of the dry cementitious materials. However, the cellulose ether derivative or its functional equivalent need not be added at this stage in the process; it only need be added at some point in the process early enough to allow it to function as a superplasticizer and/or water reducer and to assure that it mixes properly with the other ingredients of the mix design.

When the present invention is produced, manufactured, or blended as an admixture to be added to portland cement, consisting of only ultra-fine fly ash, fused silica, and a cellulose ether derivative, the preferred ranges are: from about 33% to about 67% (w/w) of ultra-fine fly ash; from about 33% to about 67% (w/w) of fused silica or its functional equivalent, and from about 0.1% to about 2.0% of cellulose ether derivative or its functional equivalent.

When the present invention is produced, manufactured, or blended as an admixture to be added to portland cement, consisting of only ultra-fine fly ash, calcined kaolin, and a cellulose ether derivative, the preferred ranges are: from about 33% to about 67% (w/w) of ultra-fine fly ash; from about 33% to about 67% (w/w) of calcined kaolin or its functional equivalent, and from about 0.1% to about 2.0% of cellulose ether derivative or its functional equivalent.

When the present invention is produced, manufactured, or blended as an admixture to be added to portland cement, consisting of only ultra-fine fly ash, calcined kaolin, and a fused silica, the preferred ranges are: from about 12.5% to about 67% (w/w) of ultra-fine fly ash; from about 17.5% to about 67% (w/w) of calcined kaolin or its functional equivalent, and from about 7% to about 22.5% of fused silica or its functional equivalent.

The cementitious products that are produced from the present invention compositions, whether introduced by inter-grinding with portland cement, by inter-blending with portland cement, or as a separate admixture to a cementitious mixture design, are superior to existing pozzolanic cementitious products in that the cementitious products produced from the present invention are: more workable, slower setting, faster reacting (chemically) with the calcium hydroxide compound of the portland cement, more rapidly decrease the permeability of the cementitious material, more resistant to water attack or chemical attack, more rapidly increase the compression strength of the cementitious material, reduce the water demand, and lower the water:cementitious ratio.

The fused silica equivalent must display a highly pozzolanic reactive, capable of reacting chemically with the calcium hydroxide compound of portland cement. Said pozzolanic reactivity must be shown by compression strength comparison testing, whereby hardened cementitious products, one with and one without the amorphous silica are tested. The amorphous silica product must be found to exhibit equal, or greater compression strength at 28 days to that of the product having only portland cement.

An admixture is described herein as an additive other than portland cement, water, sand, and/or aggregate, which is added into a cementitious product. An ingredient is described herein as one constituent of a multi-constituent admixture, addition, or product. An addition is described herein as a material, ingredient, or additive that is inter-ground or blended into a portland cement. An additive is described herein as either an addition or an admixture. These definitions follow the basic terminology found in the 2000 edition of the American Concrete Institute, ACI 116R-00, Cement and Concrete Terminology.

The pozzolan-modified inter-ground cement and the pozzolan-modified blended cement compositions of the present invention satisfy the Standards and Specifications of C595 of the (ASTM C595-Standard Specification for Pozzolan Modified Portland Cement).

Preferably, the portland cement constituent of the present invention is any portland cement that satisfies the ASTM Standards and Specifications of C150 (Types I-VIII) of the American Society for Testing of Materials (ASTM C50-Standard Specification for Portland Cement). ASTM C150 covers eight types of portland cement, each possessing different properties, and used specifically for those properties.

The term functional equivalent has been used throughout this application. As used herein, the term requires that the substitute substance allows, or enables, the final pozzolan-modified portland cementitious mixture to have comparable key characteristics as if the substitution had not taken place. These minimum strength, strength gain, cure, and other critical parameters are both well known in the art and variable depending upon the application in which the material is used.

Inert fillers or bulking agents of the present invention are fine powders of inert ingredients that may increase the paste or “creme” of the cementitious products. The preferred range of fineness is that of passing a 200 mesh (75 micron) to a 325 mesh (45 micron) or finer. Compositions such as talc, calcium bentonite, lime, calcium carbonate, dolomite, or clay, are typically used. Optimizing the gradation or fineness lends additional workability, or body, to the resulting cementitious mixture, however, it is not in this aspect a novel part or foundation of the present invention.

To further aid in the understanding of the present invention, and not by way of limitation, the following examples are presented. The ingredients of the several examples were prepared as described above.

### EXAMPLE 1

Two test samples were made and molded into 2″ times 2″ (2″×2″) cubes for compression tests to be conducted according to ASTM Standard C100. Underwater immersion was used for the method of cure.

Sample 1 was a non-pozzolan-modified cementitious product, and was prepared by combining white portland cement meeting the Standard of ASTM C150 (Type I), a limestone sand in a 1:2 mix ratio of cement to sand, and a 0.4:1 ratio of water to cementitious materials. All ingredients were combined and thoroughly mixed until well blended.

Sample 2 was a pozzolan-modified cementitious product of the present invention, and was prepared by combining the cementitious materials of about 82% (w/w) of white portland cement meeting the Standard of ASTM (Type I), 9% (w/w) of calcined kaolin, 6% (w/w) of ultra-fine fly ash, 3% (w/w) of fused silica, and about 0.05% (w/w) of a cellulose ether derivative, which produced the same plasticity, slump, or flow as in Sample 1, at only a 0.35:1 ratio of water to cementitious materials. This pozzolan-modified cementitious material was then mixed, as was Sample 1, in the same conventional manner and in accordance with ASTM Standard C100, with a 1:2 mix ratio of cement to sand, yet with only a 0.35:1 ratio of water to cementitious materials ratio. This is due to the fact that the novel invention herein allows for the same plasticity, slump, and flow characteristics as compared to Sample 1, yet with less water demand. The comparison results of the test are reported below in Table 1:

TABLE 1
Compression Strength Comparison
(measured in p.s.i. units)

| Lapsed Time | Sample 1* | Sample 2** |
|---|---|---|
| 3 days | 2800 | 2880 |
| 7 days | 3725 | 3915 |
| 28 days | 6865 | 7270 |

*Non-pozzolanic modified portland cement mixture
**Pozzolan-modified portland cement mixture of the present invention

### EXAMPLE 2

Two samples were made poured into a cylinder mold of 8″ in length times 4″ in diameter (8″ length×4″ diameter) for compression tests to be conducted pursuant to ASTM Standard C109. Underwater immersion was used for the method of cure.

Sample 1 was a non-pozzolan-modified portland cement concrete product prepared by combining a 1:2:4 mix ratio of cement to sand to ⅜″ gravel. The concrete product had 0.37:1 water to cement ratio. All ingredients were mixed until well blended in accordance with ASTM Standard C109 testing procedures.

Sample 2 was a pozzolan-modified portland cement concrete product of the present invention and was prepared by combining the cementitious materials of about 82% (w/w) of white portland cement meeting the Standard of ASTM (Type I), 8% (w/w) of calcined kaolin, 6% (w/w) of ultra-fine fly ash, 4% (w/w) of fused silica, and about 0.05% (w/w) of cellulose ether derivative, which produced the same plasticity, slump, or flow as Sample 1, yet at only a 0.32:1 ratio of water to cementitious materials. This pozzolan-modified cementitious material was then mixed, as was Sample 1, in the same conventional manner and in accordance with ASTM Standard C109, with a 1:2:4 mix ratio of cement to sand to ⅜″ gravel, yet with only a 0.32:1 ratio of water to cementitious materials. This is due to the fact that the novel invention herein allows for the same plasticity, slump, and flow characteristics as compared to Sample 1, yet with less water demand. Said pozzolan-modified cementitious material was then mixed, as was Sample 1, in the same conventional manner, and in accordance with ASTM Standard C109, with the same 1:2:4 mix ratio of cement to sand to gravel, yet with a 0.32:1 water to cementitious materials ratio. The comparison results of the test are reported below in Table 2:

TABLE 2
Compression Strength Comparison
(measured in p.s.i. units)

| Lapsed Time | Sample 1* | Sample 2** |
|---|---|---|
| 3 days | 2300 | 2525 |
| 7 days | 3510 | 3700 |
| 28 days | 4520 | 5230 |

*Non-pozzolanic modified gray portland cement mixture
**Pozzolan-modified gray portland cement mixture of the present invention

Tables 1 and 2 show a significant recovery of compression strength in the pozzolan-modified blended cementitious product. The pozzolanic cementitious products of Examples 1 and 2 can be expected to exhibit compression strengths substantially above that demonstrated by the otherwise similar non-pozzolanic products.

### EXAMPLE 3

An inter-ground pozzolan-modified portland cement was prepared by the grinding the clinker of a portland cement, with a gypsum or a hemi-hydrate form of gypsum, and with the present invention's admixture. Clinker, as described herein, is the cement material that is created after the kilning process, but prior to the grinding process. The clinker material, the gypsum material, and the pozzolanic admixture of the present invention were thoroughly ground together to create a composition containing approximately 75% (w/w) of portland cement; 20% (w/w) of calcined kaolin; 10% (w/w) of ultra-fine fly ash; and 5% (w/w) of fused silica. Approximately 0.1% (w/w) of cellulose ether derivative was then blended into this pozzolan-modified cement after the grinding process, and not during the grinding process as with the other ingredients of this examples mixture.

An exemplary use of this mixture would be for a shotcrete product that is prepared by mixing the pozzolan-modified inter-ground portland cement as prepared in this example above, with water, sand, and ⅜″ gravel, having a 1:2:4 ratio of a cement:sand:gravel mix design and sufficient supplemental water added to give the shotcrete the desired workable consistency.

### EXAMPLE 4

A blended pozzolan-modified portland cement of the present invention was prepared by thoroughly blending together a portland cement and the present invention's admixture. The portland cement and the admixture of the present invention, were blended together, to create a composition that was containing approximately 70% (w/w) of portland cement; 12% (w/w) of calcined kaolin; 12% (w/w) of ultra-fine fly ash; 6% (w/w) of fused silica; and 0.1% (w/w) of cellulose ether derivative.

An exemplary use of this mixture would be for a concrete slab or walkway that is prepared by mixing the pozzolan-modified blended portland cement as prepared in this example above, with water, sand, and aggregate, having a 1:2:4 ratio of a cement:sand:aggregate mix design and having sufficient water added to allow the concrete to be properly placed.

### EXAMPLE 5

An admixture of the present invention was prepared by mixing or blending the present invention's admixture, containing approximately; 55% (w/w) of calcined kaolin; 30% (w/w) of ultra-fine fly ash, 15% (w/w) of fused silica; and 0.5% (w/w) of cellulose ether derivative, and about 10% to 15% inert filler was added to the admixture. The filler was a an inert aluminum silica hydrate material that facilitated the proper dispersion of the present invention's ingredients as well as discourages potential copying or reverse engineering of the present invention.

An exemplary use of the pozzolan admixture would be for its subsequent addition to portland cement, sand and/or aggregate, and water, to create a pozzolan-modified cementitious product. The pozzolan-modified cementitious product of this example is prepared by mixing the present invention's admixture as prepared in this example above as a ready mix, or as a wet mix in a paddle mixer. The cementitious materials of the mix design consist of approximately 31% (w/w) of the present invention's admixture and 69% (w/w) of portland cement. The pozzolan-modified cementitious product having a 1:2:4 ratio of cement:sand:gravel mix design and having sufficient supplemental water added to allow the concrete to be properly placed.

### EXAMPLE 6

A plaster was prepared by mixing simultaneously, the present invention, with portland cement, sand, and water. The mixing of the plaster was from about a 1:2 ratio to about a 4:6 ratio of the cementitious material:sand. Water was then added to the mixture in sufficient quantity to allow the plaster to have the desired workable consistency. A strong cementitious mixture was obtained.

From the foregoing it is readily apparent that a useful embodiment of the present invention has been herein described and illustrated, which fulfills an objective that the aforestated objects perform in a remarkably unexpected fashion. It is of course understood that such modifications, alterations, and adaptations, as may readily occur to the artisan as confronted in the field of construction, with this disclosure, are intended within the spirit of this disclosure which is limited only by the scope of the claims appended hereto.

What is claimed:

1. An admixture for subsequent addition to portland cement to create a pozzolan modified portland cementitious material, said pozzolan modified portland cementitious material having from about 5% to about 35% (w/w) of said admixture blended therein, said admixture comprising: from about 5% to about 47% (w/w) of fused silica; from about 17.5% to about 67% (w/w) of calcined kaolin; from about 10% to about 57% (w/w) of ultra-fine fly ash; from about 0.5% to about 2% (w/w) of a cellulose ether derivative.

2. An admixture matter according to claim 1 wherein said calcined kaolin is ground to a fineness of at least 200 mesh (75 micron) with a maximum of about 5% retaining; said fused silica is ground to a fineness of at least 325 (45 micron) mesh with a maximum of about 5% retaining, and said ultra-fine fly ash having a fineness that is of at least 10 micron or finer.

3. An admixture according to claim 1 containing from about 33% to about 67% (w/w) of said ultra-fine fly ash; and from about 33% to about 67% (w/w) of said calcined kaolin.

4. An admixture according to claim 1 containing from about 33% to about 67% (w/w) of said ultra-fine fly ash; and from about 33% to about 67% (w/w) of said fused silica.

5. An admixture according to claim 1 containing from about 17.5% to about 67% (w/w) of said ultra-fine fly ash; from about 20% to about 67% (w/w) of said calcined kaolin; and from about 7% to about 22.5% (w/w) of said fused silica.

6. An admixture according to claim 1 containing from about 12.5% to about 67% (w/w) of said ultra-fine fly ash; from about 17.5% to about 67% (w/w) of said calcined kaolin; from about 7% to about 22.5% (w/w) of said fused silica; and from about 0.1% to about 2.0% (w/w) of said cellulose ether derivative.

7. A composition of matter comprising water, sand and/or aggregate, and a pozzolan modified portland cement containing portland cement and from about 5% to about 35% (w/w) of the admixture of claim 1.

8. A composition comprising the admixture of claim 1, adapted for use in general construction.

9. A composition comprising the admixture of claim 1, adapted for use in the construction of structures to be exposed to water.

10. A composition comprising the admixture of claim 1, adapted for the construction of pre-cast members.

11. A composition comprising the admixture of claim 1, adapted for the construction of pre-fabricated units for the construction of buildings.

12. A composition of matter comprising water and a quantity of dry materials including from about 65% to about 88% (w/w) of portland cement; from about 5% to about 27% (w/w) of calcined kaolin; from about 3% to about 27% (w/w) of ultra-fine fly ash; from about 1% to about 15% (w/w) of fused silica; and from about 0.05% to about 1.0% of a cellulose ether derivative, said weight percentages (w/w) being taken relative to the total weight of said quantity of dry materials.

13. A composition of matter according to claim 7 containing a functional equivalent to fused silica consisting of an amorphous silica such as micro-silica or silica fume in place of the fused silica having a fineness of at least 325 mesh (45 micron), and having no more than 5% retained.

14. A composition of matter according to claim 7 containing a functional equivalent to calcined kaolin consisting of a calcined natural pozzolan of a fineness at least 200 mesh (75 micron), having no more than 5% retained.

15. A composition of matter according to claim 12 containing from about 65% to about 88% (w/w) of said portland cement; from about 5% to about 27% (w/w) of calcined kaolin; from about 3% to about 27% (w/w) of ultra-fine fly ash; from about 1% to about 15% (w/w) of fused silica.

16. A composition of matter according to claim 12 containing from about 65% to about 88% (w/w) of said portland cement; from about 3% to about 27% (w/w) of ultra-fine fly ash; from about 1% to about 15% (w/w) of fused silica, and from about 0.05% to about 1.0% of a cellulose ether derivative.

17. A composition of matter according to claim 12 containing from about 60% to about 85% (w/w) of said portland cement; from about 5% to about 27% (w/w) of calcined kaolin; from about 3% to about 27% (w/w) of ultra-fine fly ash; and from about 0.05% to about 1.0% (w/w) of a cellulose ether derivative.

18. A composition of matter according to claim 12 containing a functional equivalent to fused silica consisting of an amorphous silica, such as micro-silica or silica fume, in place of the fused silica having a fineness of at least 325 mesh (45 micron) and no more than 5% retained.

19. A composition of matter according to claim 12 containing a functional equivalent to calcined kaolin consisting of a calcined natural pozzolan having a fineness at least 200 mesh (75 micron) and no more than 5% retained.

20. A composition of matter according to claim 12 wherein said calcined kaolin is ground to a fineness of at least 200 mesh (75 micron) with a maximum of about 5% retaining; and said fused silica is of a fineness of at least 325 (45 micron) mesh with a maximum of about 5% retaining, and a ultra-fine fly ash having a fineness of at least 10 micron.

21. A composition of matter comprising sand, and/or aggregate, and the composition of claim 12.

22. A composition of matter according to claim 12 in which said dry materials are mixed with water, and sand and/or aggregate, during job mixing.

23. A composition of matter according to claim 18 in which said dry materials are mixed with water, and sand and/or aggregate, during job mixing.

24. A composition comprising the composition of claim 12, adapted for use in general construction.

25. A composition comprising the composition of claim 12, adapted for use in the construction of structures to be exposed to water.

26. A composition comprising the composition of claim 12, adapted for the construction of pre-cast members.

26. A composition comprising the composition of claim 12, adapted for the construction of pre-fabricated units for the construction of buildings.

27. A composition of matter according to claim 12 in which said water is mixed with said dry materials during job mixing.

28. A composition of matter according to claim 18 in which said water is mixed with said dry materials during job mixing.

29. A composition of matter according to claim 19 in which said water is mixed with said dry materials during job mixing.

30. A pozzolan-modified blended or inter-ground portland cement containing comprising from about 60% to about 88% (w/w) of portland cement thoroughly blended or inter-ground with a single composition addition, or with multiple component additions, or with individual component additions, that are the collective equivalent of the present invention, comprising; from about 65% to about 88% (w/w) of portland cement, from about 5% to about 27% (w/w) of calcined kaolin, from about 3% to about 27% (w/w) of ultra-fine fly ash, from about 1% to about 15% (w/w) of fused silica, and from about 0.05% to about 1.0% of a cellulose ether derivative.

31. A composition of matter according to claim 30 additionally comprising water, sand and/or aggregate.

32. A composition comprising the pozzolanic portland cement of claim 30, adapted for use in general construction.

33. A composition comprising the pozzolanic portland cement of claim 30, adapted for use in the construction of structures to be exposed to water.

34. A composition comprising the pozzolanic portland cement of claim 30, adapted for the construction of pre-cast members.

35. A composition comprising the pozzolanic portland cement of claim 30, adapted for the construction of pre-fabricated units for the construction of buildings.

36. A composition of matter according to claim 30 containing a functional equivalent to fused silica consisting of an amorphous silica, such as micro-silica or silica fume, in place of the fused silica having a fineness of at least 325 mesh (45 micron), and having no more than 5% retained.

37. A composition of matter according to claim 30 containing a functional equivalent to calcined kaolin consisting of a calcined natural pozzolan having a fineness at least 200 mesh (75 micron), and having no more than 5% retained.
